(19) United States
(12) Patent Application Publication
(10) Pub. No.: US 2023/0083911 A1
(43) Pub. Date: Mar. 16, 2023

(54) SYSTEM AND METHOD FOR AN ELECTRONIC SIGNATURE DEVICE

(71) Applicants: Jonathan SIEGEL, Beaverton, OR (US); James WEISSER, Beaverton, OR (US)

(72) Inventors: Jonathan SIEGEL, Beaverton, OR (US); James WEISSER, Beaverton, OR (US)

(21) Appl. No.: 17/729,010

(22) Filed: Apr. 26, 2022

Related U.S. Application Data
(63) Continuation of application No. 17/168,280, filed on Feb. 5, 2021, now abandoned.

(51) Int. Cl. G06F 3/0346; G06F 21/32; G06Q 10/10

(52) U.S. Cl. CPC G06F 3/0346; G06F 21/32; G06Q 10/10

(57) ABSTRACT

An electronic stamp device, embodied in a physical object, which is secure and which is able to provide a verifiable electronic signature. The electronic stamp device comprises a touchpoint detection technology for detecting a plurality of touchpoints when the device is applied to a document, whether electronic or physical. The touchpoint detection technology may for example comprise any suitable sensor or combination thereof, including but not limited to an accelerometer, a gyroscope, a magnetometer or an IMU (inertial measurement unit), a pressure sensor, or a combination thereof. The accelerometer may comprise a 3D accelerometer. The gyroscope may comprise a 3D gyroscope. An IMU includes an accelerometer and a gyroscope. A plurality of such sensors may also be provided.

### FIELD OF THE INVENTION

The present invention relates generally to a system and method for electronic signatures, and more specifically to such a system and method for electronic signatures with a physical device.

### BACKGROUND

Physical signatures, for example for indicating authorization of or assent to a document and/or action, may take many forms. Many countries have traditionally used hand written signatures as binding indications of authorization or assent, whether for individuals or companies. In the case of companies, the hand written signature would be provided by an individual who is authorized to sign on behalf of the company.

In other countries, the use of a physical device with a stamp is traditionally used in place of hand written signatures. The physical device may be a “chop” or “hanko” for example. The physical device with the stamp may be used to indicate authorization or assent for individuals or companies. In the case of companies, an additional complication arises in that revocation of an individual's authority to bind the company may be difficult or impossible if that individual retains the company's physical signature device(s).

Various solutions have been considered for electronic devices to replace the physical devices. However, these solutions suffer from a variety of deficiencies. In particular, these solutions generally require a special electronic device to act as the surface for receiving the signature, in addition to the electronic stamp or “chop”/“hanko” physical signature device.

### SUMMARY

The background an does not teach o suggest an electronic stamp device, embodied in a physical object, which is secure yet is able to provide an electronic signature without requiring an additional electronic device. The background art also does not teach or suggest such an electronic stamp device which uses touchpoint detection for providing additional security for electronic signatures.

The present invention, in at least some embodiments, provides an electronic stamp device, embodied in a physical object, which is secure and which is able to provide a verifiable electronic signature. The electronic stamp device comprises a touchpoint detection technology for detecting a plurality of touchpoints when the device is applied to a document, whether electronic or physical. The touchpoint detection technology may for example comprise any suitable sensor or combination thereof, including but not limited to an accelerometer, a gyroscope, a magnetometer or an IMU (inertial measurement unit), a pressure sensor, or a combination thereof. The accelerometer may comprise a 3D accelerometer. The gyroscope may comprise a 3D gyroscope. An IMU includes an accelerometer and a gyroscope. A plurality of such sensors may also be provided.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention.

In this regard, no attempt is made to show structural details of the invention in more detail than is necessary for a fundamental understanding of the invention, the description taken with the drawings making apparent to those skilled in the art how the several forms of the invention may be embodied in practice. These and other features, aspects, and advantages of the present invention will become better understood with regard to the following description, appended claims, and accompanying drawings where:

FIG. 1A shows a system for an electronic signature device according to at least some embodiments.

FIG. 1B shows an alternative embodiment of the system according to at least some embodiments.

FIG. 1C shows another alternative embodiment of the system according to at least some embodiments.

FIG. 2A shows a non-limiting exemplary electronic signature device as shown in FIG. 1.

FIG. 2B shows the nonlimiting exemplary additional implementation of the electronic signature device as shown in FIG. 1A.

FIG. 3 shows a nonlimiting exemplary flow for enabling the user to authenticate to the electronic signature device and then to sign a document.

### DETAIL DESCRIPTION OF THE INVENTION

In describing the novel system and method for a secure electronic signature device, the provided examples should not be deemed to be exhaustive. While one implementation is described hereto, it is to be understood that over variations are possible without departing from the scope and the nature of present invention.

Turning now to the drawings, there are shown, a system and method and at least some exemplary embodiments for an electronic signature device that is capable of signing documents in a variety of media including without limitation, paper or other solid media and digital media.

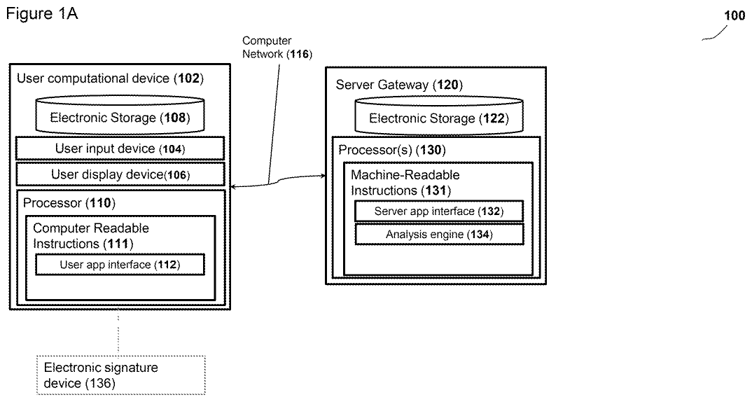

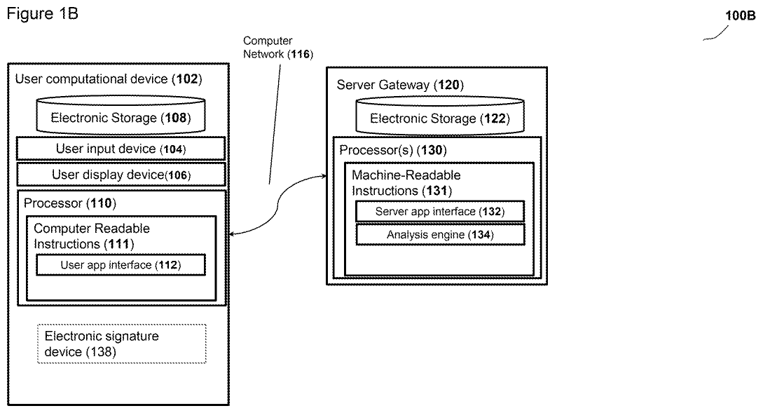

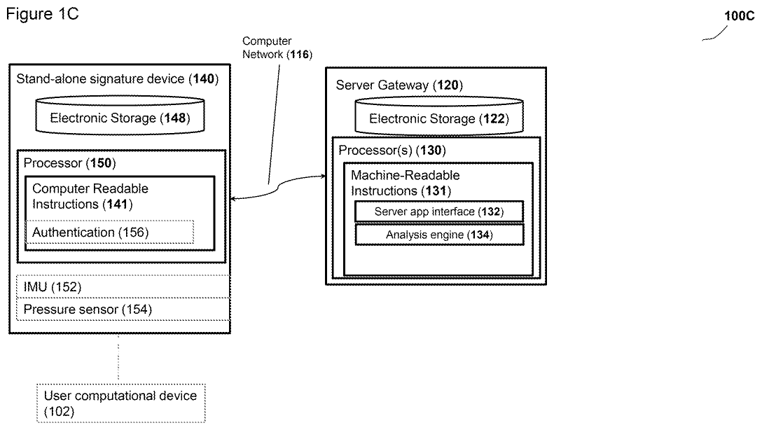

FIG. 1A shows a system for an electronic signature device according to at least some embodiments. As shown in FIG. 1A, the system 100 comprises a user computational device 102, a server gateway 112, and an electronic signature device 136. The user computational device 102 and the server gateway 120 preferably communicate through a computer network 116.

The user computational device 102 features electronic storage 108 for storing information and data, including without limitation one or more programs or computer information. The user computational device 102 also comprises a user input device 104, user display device 106, a processor 110, and computer readable instructions 111. Computer readable instructions 111 comprises instructions for operating user computational device 102 including without limitation user app interface 112. The user computational device 102 is in communication with electronic signature device 136, where such communication may be direct wire communication, or alternatively wireless communication.

The electronic signature device 136 enables the user to sign a document, whether on a solid media or physical media such as paper, or alternatively on a digital media. As the user signs the document through the electronic signature device 136, the electronic signature device 136 communicates information to the user computational device 102, where the information includes without limitation the location of the signature, user authentication, and optionally also pressure or other sensor indications that in fact, the document has been signed.

The electronic signature device 136 may operate, for example, in the form of a chop or hanko, where the act of the user pressing the electronic signature device 136 to a document—whether on a physical media, or solid media such as paper, or a digital media—indicates that the document has in fact been signed. Optionally, the electronic signature device 136 requires an user authentication, whether the authentication is through the device itself, or alternatively through user computational device 102. Optionally, the user may choose to download a hanko or chop signature indication to the electronic signature device 136 through the user computational device 102.

Alternatively, the electronic signature device 136 may come with one or more hanko(es) or chop(s) preloaded, which are then enabled for the user to operate. Optionally, however, such authorization is required to be renewed before the signature can be accepted. For example, if the user no longer has authorization to use a particular hanko or chop insignia, then the electronic signature device 136 no longer has the authorization and is no longer operative, at least with regard to that particular form of chop or hanko. Information from the electronic signature device 136 is communicated to the user computational device 102 and then is communicated to the server gateway 120 through the computer network 116.

The server gateway 120 comprises an electronic storage 122, a processor 130, and machine readable instructions 131. The machine readable instructions 131 include a server app interface 132 for communicating to and receiving information from the user computational device 102. The machine readable instructions 131 also include instructions for operating an analysis engine 134, for example, for supporting authentication of the user and/or electronic signature device 136.

Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 111 in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 111 is configured for storing a defined native instruction set of codes. Processor 110 is configured to perform a defined set of basic operations in response to receiving a corresponding basic instruction selected from the defined native instruction set of codes stored in memory 111. For example and without limitation, memory 111 may store a first set of machine codes selected from the native instruction set for receiving document information from the user through user app interface 112 and a second set of machine codes selected from the native instruction set for transmitting such information to server gateway 120 in regard to a document for signature. Optionally, electronic device 136 communicates with user computational device 102, such that memory 111 stores a third set of machine codes selected from the native instruction set for transmitting electronic signature authorization in regard to the specific document to be signed.

Optionally and preferably, memory 111 stores a fourth set of machine codes selected from the native instruction set for receiving touchpoint detection data from electronic device 136, and a fifth set of machine codes selected from the native instruction set for transmitting such touchpoint detection data to server gateway 120.

In regard to the touchpoint detection data, preferably electronic device 136 comprises a suitable touchpoint detection technology for detecting a plurality of touchpoints. The touchpoint detection technology may for example comprise any suitable sensor or combination thereof, including but not limited to an accelerometer, a gyroscope, a magnetometer or an IMU (inertial measurement unit), a pressure sensor, or a combination thereof. The accelerometer may comprise a 3D accelerometer. The gyroscope may comprise a 3D gyroscope. An IMU includes an accelerometer and a gyroscope. A plurality of such sensors may also be provided. The touchpoint detection technology preferably is also able to detect an order and/or relative location of the touchpoints, and/or relative rate at which the touchpoints are created as electronic device 136 is brought into contact with the document to be signed.

Similarly, server gateway 120 preferably comprises processor 130 and memory with machine readable instructions 131 with related or at least similar functions, including without limitation functions of server gateway 120 as described herein. For example and without limitation, memory 131 may store a first set of machine codes selected from the native instruction set for receiving document information from user computational device 102, a second set of machine codes selected from the native instruction set for receiving signature information from electronic signature device 136, whether directly or indirectly, and a third set of machine codes selected from the native instruction set for executing functions of analysis engine 134, including without limitation determining signature authorization and application to a particular document. The signature information preferably includes the touchpoint detection data from the touchpoint detection technology, which is then preferably analyzed by analysis engine 134 as part of the authorization process.

FIG. 1B shows an alternative embodiment of a system according to at least some embodiments. The system 100B features an electronic signature device 138, which is integrally formed with or physically connected to an user computational device 102. The electronic signature device 138 may otherwise operate similarly to that of electronic signature device 136 as shown in FIG. 1A, but may, for example, form part of a mobile phone or may be attached to a mobile phone—as for example, a dongle or other direct attachment.

The electronic signature device 138 may also be connected with or integrally formed with a user computational device 102, which may for example be a laptop or an iPad.

The electronic signature device 138 preferably features the same or similar technology as described for FIG. 1A, for example in regard to the touchpoint detection technology, such as with regard to the sensors for example. The previously described instructions stored in memory 111 preferably also comprise instructions for transmitting data, including but not limited to with regard to authorization and/or touchpoint detection data, to server gateway 120.

FIG. 1C shows yet another alternative embodiment of the system, now shown as system 100C. As shown in system 100C, a standalone signature device 140 communicates directly with a server gateway 120 through a computer network 116. The standalone signature device 140 comprises many of the components as previously shown of the user computational device 102, including electronic storage 148, a processor 150, and computer readable instructions stored in a memory 141. The computer readable instructions in memory 141 now support authentication 156 for authenticating a user and/or for authenticating the signature or indication itself. The instructions preferably also comprise instructions for communicating authentication to server gateway 120.

Authentication 156 may also act to authenticate standalone signature device 142 to the server gateway 120 so that the signature or other indicia are in fact accepted as being legitimate. The standalone signature device 140 also preferably comprises an inertial measurement unit (IMU) 152 and/or pressure sensor 154, which as previously described are non-limiting examples of touchpoint detection technology. The IMU 152 may be used, for example, to provide readings from an accelerometer, gyroscope and so forth to indicate the orientation of the standalone signature device 140 and also to indicate that a signature has actually occurred.

Additionally or alternatively, the pressure sensor 154 may indicate that the standalone signature device 140 has actually been pressed against a document, whether the document is in solid or physical form, such as paper, or alternatively, whether the document is in digital form. In either case, optionally, the user may be required to perform authentication through the user computational device 102 either because the electronic document is stored on user computational device 102 or, alternatively, because the user is required to provide authentication through the standalone signature device 140 through authentication module 156, so that the user is authenticated and so that the signature or other indicia are accepted as being authentic. Document information may be transmitted directly from user computational device 102 to server gateway 120 (not shown) or may be transmitted to standalone signature device 140, and then to server gateway 120.

Preferably, standalone signature device 140 comprises instructions stored in memory 141 for touchpoint detection through processing data from the previously described IMU 152 and/or pressure sensor 154. As previously described, touchpoint detection may comprise detecting an order of touchpoints, an amount of pressure, a speed of touchpoint appearance and so forth. Such information may then be processed through authentication 156 and then transmitted to server gateway 120.

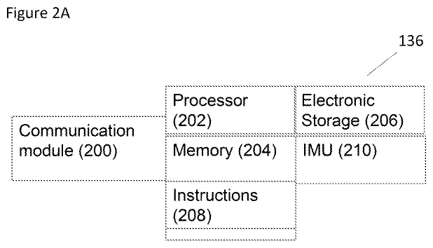

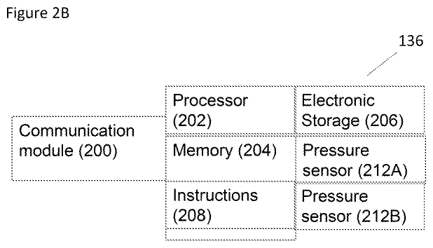

FIG. 2A shows a nonlimiting exemplary electronic signature device as shown in FIG. 1. The electronic signature device 136 is shown comprising a communication module 200 to enable communication with a user computational device 102. In addition, the electronic signature device 136 preferably comprises a processor 202 and a memory 204.

The memory 200 provides instructions 208. These instructions 208 may be provided as firmware which may be rewritable, or alternatively, may be only written once and read many times. Instructions 208 preferably comprise instructions for analyzing touchpoint detection data and then providing authentication. Optionally, the electronic storage 206 provides for additional instructions or additional data for example, for storing one or more indicia or signatures, which are then associated with the electronic signature device 136.

In this implementation, the electronic signature device 136 features in IMU 210, as previously described, for providing information relation to orientation and acceleration in order to indicate that a signature has actually been performed. Such information is preferably analyzed according to instructions 208 to provide touchpoint detection data. The fact that a signature is registered and performed may then be analyzed through instructions 208 through processor 202 and the information sent to the user computational device not shown through communication module 200.

FIG. 2B shows the nonlimiting exemplary additional implementation of the electronic signature device 136 as shown in FIG. 1A. As shown, FIG. 2B replaces the IMU with a pressure sensor 212A and a pressure sensor 212B, preferably a plurality of such pressure sensors 212 are shown, including at least two but optionally three or more pressure sensors 212. Each pressure sensor registers pressure when the electronic signature device 136 is pressed against the document, whether the document is in solid physical form, for example paper, or alternatively in electronic form as an electronic document; thereby, indicating that the act of signing has occurred.

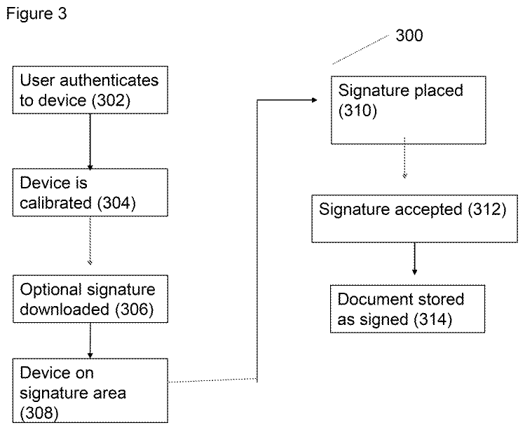

FIG. 3 shows a nonlimiting exemplary flow for enabling the user to authenticate to the electronic signature device 136 and then to sign a document. As shown in the flow 300, the flow begins at 302 when the user authenticates the device. The user may authenticate the device directly as a standalone electronic signature device 142; or alternatively, indirectly, for example, through a user computational device, as shown with regard to FIG. 1.

Upon authentication, the device is calibrated at 304. This may, for example, include having these perform one or more actions with the device where they are oriented in various ways or pressing it onto a solid substrate—for example, for pressure sensors—in order for the device to be able to register the sensors, confirm that the sensors are working properly, and calibrate the sensors function for later accuracy of measurement.

Optionally, a signature is downloaded at 306, for example as a file. This may occur for example, if the standalone electronic signature device 142 is capable of storing a plurality of signatures, such signatures may be stored events, but optionally for security reason, the signature may only be downloaded just before use, and then erased from memory of electronic signature device 136 in order to require re-authentication and reconnection to a source of authentication through another remote device. Authentication may be required each time even if a signature has been previously downloaded.

The device is placed on the signature area of a document at 308 and then the signatures placed at 310, in order for the document to be signed. For example, in the case of a chop or hanko, optionally the device is pressed against a physical substrate, such as solid media including but not limited to paper, or alternatively, such as an electronic document in which case the pressure be placed against the screen. Next, the signatures are accepted at 312. Whether through a combination of authentic authentication, understand this signature has been placed and accepted or other information. The document is then stored as signed at 314.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An electronic signature device for applying an electronic signature to a document upon authorization of a signing user, comprising touchpoint detection technology, a memory for storing a plurality of instructions and a processor for executing said instructions, wherein said instructions comprise instructions for an electronic signature, wherein the signing user physically manipulates the device to physically touch the document to sign, wherein said touchpoint detection technology detects physically touching the document at a plurality of touchpoints, wherein said processor executes instructions for the electronic signature upon detection of said plurality of touchpoints.

2. The device of claim 1, wherein the document comprises an electronically stored document and wherein said touchpoint detection technology detects physically touching a representation of the document.

3. The device of claim 1, wherein the document comprises a physical medium and wherein said touchpoint detection technology detects physically touching said physical medium.

4. The device of claim 1, wherein said touchpoint detection technology comprises a sensor selected from the group consisting of a accelerometer, a gyroscope, a magnetometer or an IMU (inertial measurement unit), a pressure sensor, or a combination thereof, and wherein said processor receives touchpoint detection data from said sensor or combination of sensors.

5. The device of claim 4, wherein said accelerometer comprises a 3D accelerometer.

6. The device of claim 5, wherein said gyroscope comprises a 3D gyroscope.

7. The device of claim 4, wherein said touchpoint detection technology comprises an IMU and a pressure sensor.

8. The device of claim 7, wherein said touchpoint detection technology detects an order and/or relative location of the touchpoints, and/or relative rate at which the touchpoints are created as the device is brought into contact with the document to be signed.

9. The device of claim 7, wherein said touchpoint detection technology provides data to said processor and said processor executes instructions stored in said memory for detecting an order and/or relative location of the touchpoints, and/or relative rate at which the touchpoints are created as the device is brought into contact with the document to be signed.

10. The device of claim 9, wherein said memory is configured for storing a defined native instruction set of codes and said processor is configured to perform a defined set of basic operations in response to receiving a corresponding basic instruction selected from the defined native instruction set of codes stored in memory; wherein said memory stores a first set of machine codes selected from the native instruction set for receiving touchpoint detection data from said sensor or combination of sensors and a second set of machine codes selected from the native instruction set for analyzing a plurality of touchpoints according to said touchpoint detection data.

11. The device of claim 10, wherein said memory stores a third set of machine codes selected from the native instruction set for receiving an authorization of the signing user and a fourth set of machine codes selected from the native instruction set for applying the electronic signature.

12. A system for applying an electronic signature to a document upon authorization of a signing user, comprising the device of claim 9 and further comprising a user computational device, wherein the document is accessible through said user computational device, and wherein application of the electronic signature is transmitted from the device of claim 9 to said user computational device.

13. The system of claim 12, wherein said user computational device comprises a mobile communication device.

14. The system of claim 12, wherein said user computational device comprises a second memory and a second processor, wherein said second memory is configured for storing a defined native instruction set of codes and said second processor is configured to perform a defined set of basic operations in response to receiving a corresponding basic instruction selected from the defined native instruction set of codes stored in said second memory; wherein said second memory stores a first set of machine codes selected from the native instruction set for receiving touchpoint detection data from the device of claim 9 and a second set of machine codes selected from the native instruction set for analyzing a plurality of touchpoints according to said touchpoint detection data.

15. The system of claim 14, wherein said second memory stores a third set of machine codes selected from the native instruction set for receiving said authorization of said signing user, wherein said electronic signature is not applied to said document if said authorization is not received.

16. The system of claim 15, wherein said user computational device further comprises a user app interface and wherein said second memory stores a fourth set of machine codes selected from the native instruction set for operating said user app interface and a fifth set of machine codes selected from the native instruction set for receiving document information from the user through said user app interface.

17. The system of claim 16, further comprising a server gateway and a computer network, wherein said user computational device is in communication with said server gateway through said computer network, wherein said second memory stores a sixth set of machine codes selected from the native instruction set for transmitting such information to said server gateway in regard to a document for signature.

18. The system of claim 17, wherein said server gateway comprises a third processor and a third memory, wherein said third memory is configured for storing a defined native instruction set of codes and said third processor is configured to perform a defined set of basic operations in response to receiving a corresponding basic instruction selected from the defined native instruction set of codes stored in said third memory; wherein said third memory stores a first set of machine codes selected from the native instruction set for receiving document information from said user computational device, a second set of machine codes selected from the native instruction set for receiving signature information from the device of claim 9, whether directly or indirectly, and a third set of machine codes selected from the native instruction set for executing functions of an analysis for determining signature authorization and application to a particular document.

19. The system of claim 18, wherein said user computational device is in wireless or wired communication with the device of claim 9.

20. The system of claim 18, wherein said user computational device is connected to or integrally formed with the device of claim 9.
